(19) United States
(12) Patent Application Publication
(10) Pub. No.: US 2009/0038940 A1
(43) Pub. Date: Feb. 12, 2009

(54) Reference Electrode

(75) Inventors: Shen-Kan Hsiung, Tao-Yuan (TW); Jung-Chuan Chou, Tao-Yuan (TW); Tai-Ping Sun, Tao-Yuan (TW); Nien-Hsuan Chou, Tao-Yuan (TW)

Correspondence Address: WPAT, PC, 7225 BEVERLY ST., ANNANDALE, VA, 22003, US

(73) Assignee: CHUNG YUAN CHRISTIAN UNIVERSITY, Tao-Yuan (TW)

(21) Appl. No.: 12/168,992

(22) Filed: Jul. 8, 2008

Related U.S. Application Data
(60) Provisional application No. 60/954,327, filed on Aug. 7, 2007.

(51) Int. Cl. G01N 27/30

(52) U.S. Cl. 204/421; 204/435; 204/294; 427/58

(57) ABSTRACT

The present invention discloses a reference electrode. According to the invention, a capillary structure is plugged in a solid state electrolyte layer of the reference electrode. By capillary phenomenon, a test solution is sucked to the solid state electrolyte layer to have reaction. Therefore, according to the invention, a test solution can be measured by simply placing the capillary structure of the reference electrode into the test solution. The lifetime of the reference electrode can be greatly extended.

### BACKGROUND OF THE INVENTION

1. Field of the Invention

The present invention is generally related to a reference electrode.

2. Description of the Prior Art

Accompanying with technology advance and living requirements, many electronic and chemical measurement devices become smaller. Thus, in order to fulfill the needs in delicate devices, many fabrication methods and tools are improved and invented continuously.

The common reference electrode is made by covering electrolyte solution with glass or ceramics. However, such a reference electrode is bulky because it is made of glass or ceramics and thus it has problems like difficulty in fabrication, easily damaged structure, high cost, etc.

Furthermore, the traditional reference electrode has to be placed in a test solution. This causes the electrolyte solution to vanish easily. On the other hand, the reference electrode is apt to be corroded by test solutions when dipping in the solutions. It results in device damage.

### SUMMARY OF THE INVENTION

In light of the above background, in order to fulfill the requirements of the industry, the present invention provides a reference electrode to solve the problems occurred in the prior art.

One object of the present invention is to provide a reference electrode, comprising a substrate, a solid state electrolyte layer provided on the substrate, a conducting structure, and a capillary structure. The solid state electrolyte layer is polymerized colloidal electrolyte solution. The conducting structure and the capillary structure contact with the solid state electrolyte layer, separately. A test solution is sucked by the capillary structure to reach the solid state electrolyte layer to have reaction. Therefore, the measurement can be performed by simply placing the capillary structure into the test solution.

### BRIEF DESCRIPTION OF THE DRAWINGS

FIGS. 1-4 show schematic diagrams illustrating the structure of a reference electrode;

FIG. 5 shows a schematic diagram illustrating the structure of a sensing device;

FIGS. 6 and 7 show schematic diagrams illustrating the structure of a working electrode; and

FIGS. 8-11 show schematic diagrams illustrating the processes of fabricating a reference electrode.

### DESCRIPTION OF THE PREFERRED EMBODIMENTS

What is probed into the invention is a reference electrode. Detail descriptions of the steps and compositions will be provided in the following in order to make the invention thoroughly understood. Obviously, the application of the invention is not confined to specific details familiar to those who are skilled in the art. On the other hand, the common structures or steps that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

The invention provides a reference electrode, comprising a substrate, a solid state electrolyte layer provide on the substrate, a conducting structure, and a capillary structure. The solid state electrolyte layer is polymerized colloidal electrolyte solution. The conducting structure and the capillary structure contact with the solid state electrolyte layer, separately. When the capillary structure is placed in a test solution, the ions in the test solution are sucked by the capillary structure to reach the solid state electrolyte layer to have ion exchange with the ions in the solid state electrolyte layer. Then, the solid state electrolyte layer performs ion exchange with the conducting structure. Thus, the back-end signal processing device can analyze the test solution according to the ion exchange result of the conducting structure. The reference electrode according to the invention can achieve the above purpose by various structures.

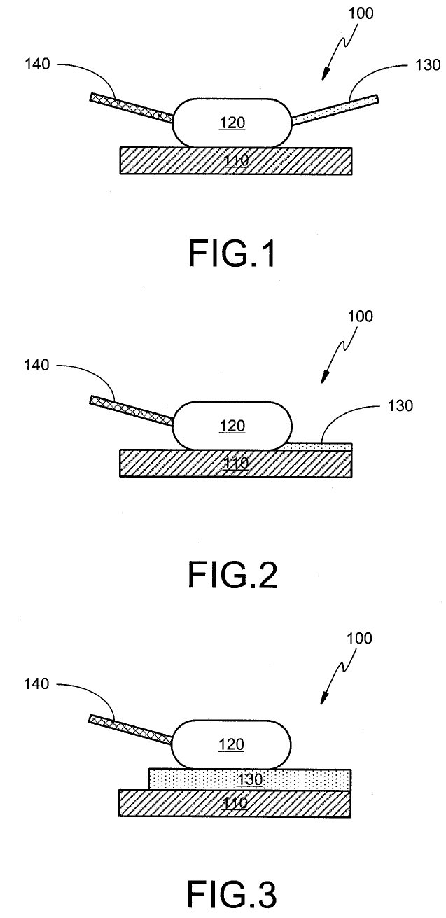

Referring to FIG. 1, the reference electrode 100 comprises a substrate 110, a solid state electrolyte layer 120, a conducting structure 130, and a capillary structure 140. The conducting structure 130 is a conducting wire and the solid state electrolyte layer 120 is polymerized colloidal electrolyte solution. The solid state electrolyte layer 120 is located on the substrate 100 and the conducting structure 130 and the capillary structure 140 are placed in the colloidal electrolyte solution before polymerization.

FIG. 2 shows another structural schematic diagram of a reference electrode 100 where the solid state electrolyte layer 120 and the conducting structure 130 are both on the substrate 110 and contact with each other. The conducting structure 130 is a conducting layer and the capillary structure 140 is placed in the colloidal electrolyte solution before polymerization.

As shown in FIG. 3, the conducting structure 130 is a conducting layer positioned between the substrate 110 and the solid state electrolyte layer 120. The capillary structure 140 is placed in the colloidal electrolyte solution before polymerization.

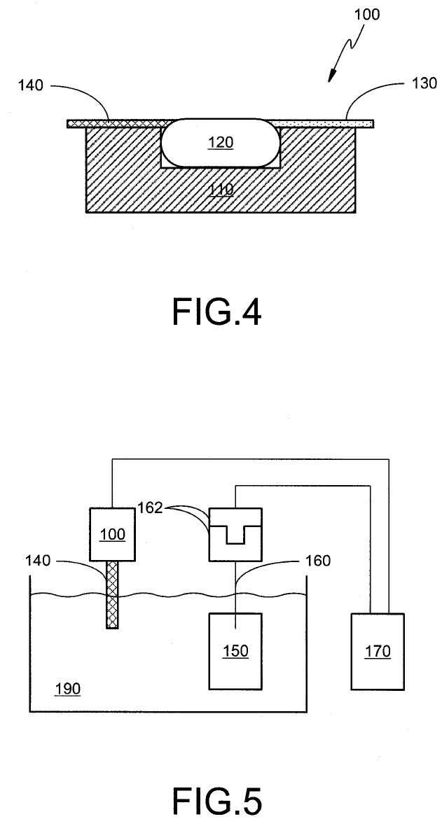

As shown in FIG. 4, the solid state electrolyte layer 120 is fixed in a groove of the substrate 110. The conducting structure 130 and the capillary structure 140 are both on the substrate 110 and separately connect to the solid state electrolyte layer 120.

Furthermore, as shown in FIG. 5, a sensing device to measure a test solution 190 has to comprise the above mentioned reference electrode 100 and a working electrode 150. When the working electrode 150 and the capillary structure 140 of the reference electrode 100 are both placed in the test solution 190 at the same time, the test solution 190 is sucked to the solid state electrolyte layer 120 to have reaction through the capillary structure 140. Thus, an electrical potential difference is generated between the reference electrode 100 and the working electrode 150.

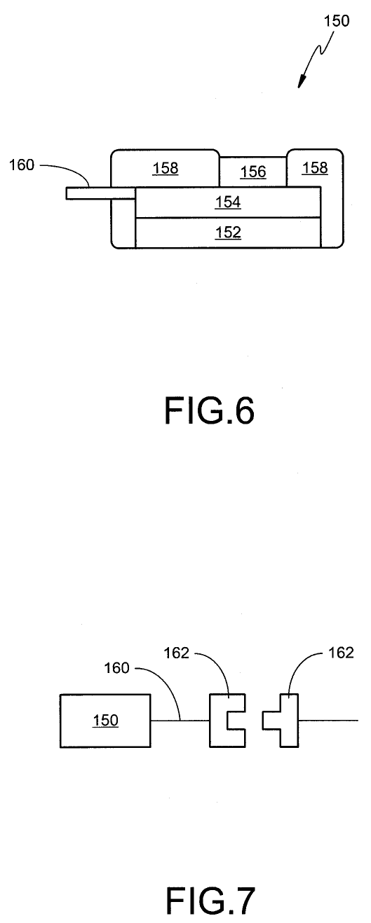

As shown in FIG. 6, the working electrode 150 comprises a substrate 152, an indium tin oxide layer (ITO) 154, a sensing layer 156 and a sheathing layer 158. The indium tin oxide layer 154 is positioned on the substrate 152 and the sensing layer 156 is on the indium tin oxide layer 154. The sheathing layer 158 is positioned on the area besides the sensing layer 156. Thus, the sensing layer 156 can be in contact with the test solution and also the other portion of the working electrode 150 can be protected.

In order to measure the different compositions in the test solution 190, the sensing layer 156 comprises one film selected from the group consisting of the following or any combination thereof: potassium sensing film, sodium sensing film, chlorine sensing film, ammonium sensing film, urea enzyme film, creatinine enzyme film, and glucose enzyme film. Besides, the sheathing layer can be of thermosetting material, such as epoxy compounds. In addition, the substrate 152 of the working electrode 150 comprises one substance selected from the group consisting of the following or combination thereof: polycarbonate, polyester, polyether, polyamide, polyurethane, polyimide, polyvinyl chloride (PVC), glass, glass fiber plate, ceramics, polyethylene terephthalate (PET).

As shown in FIGS. 5 and 6, the reference electrode 100 and the working electrode 150 separately connect to a signal processing device 170. The working electrode 150 connects to the signal processing device 170 via a conducting wire 160 and the conducting wire 160 connects to the indium tin oxide layer 154 of the working electrode 150. The signal processing device 170 receives and processes the signals outputted by the reference electrode 100 and the working electrode 150 so as to analyze the test solution 190.

Moreover, as shown in FIGS. 5 and 7, the working electrode 150 can further comprise a detachable element to replace the working electrode 150 with different one. The working electrode 150 can be reused.

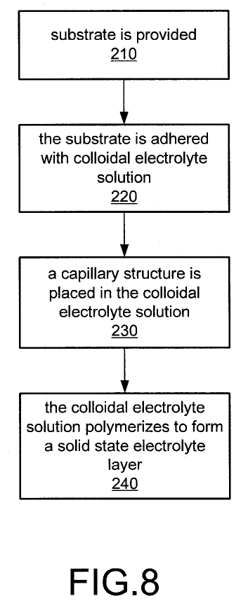

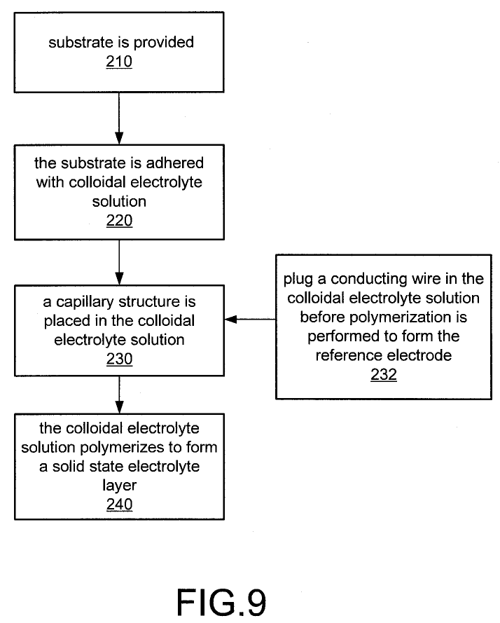

According to the above mentioned structure of the reference electrode, the invention provides a method for fabricating a reference electrode, comprising the following steps. As shown in FIG. 8, at first in step 210, a substrate is provided. In step 220, the substrate is adhered with colloidal electrolyte solution. Then, in step 230, a capillary structure is placed in the colloidal electrolyte solution. In step 240, the colloidal electrolyte solution polymerizes to form a solid state electrolyte layer. As shown in FIG. 9, before step 240, a step 232 to plug a conducting wire in the colloidal electrolyte solution before polymerization is performed to form the reference electrode in FIG. 1.

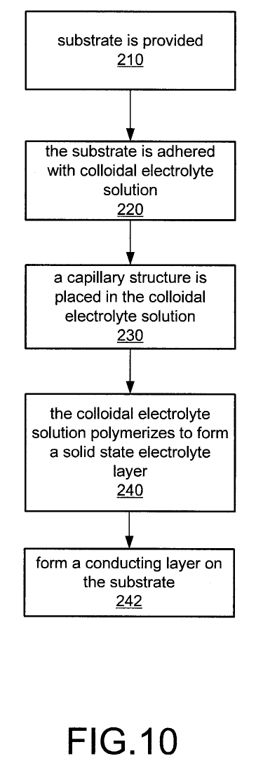

As shown in FIG. 10, after the step 240 in FIG. 8, a step 242 to form a conducting layer on the substrate can be performed where the conducting layer connects to the solid state electrolyte layer. Thus, the reference electrode in FIG. 2 can be formed.

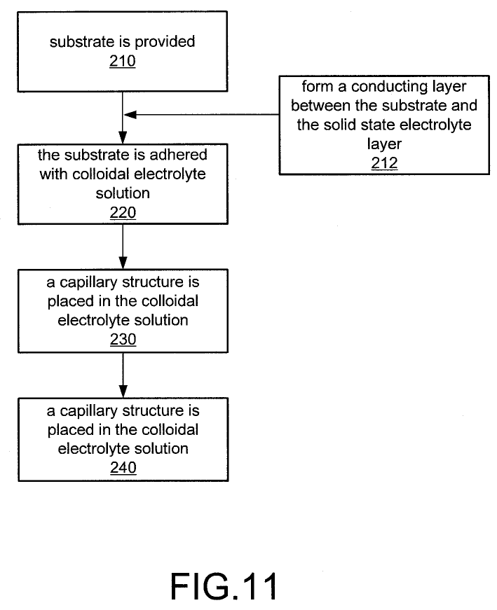

Furthermore, as shown in FIG. 11, before the step 220 in FIG. 8, a step 212 to form a conducting layer on the substrate can be performed so as to have the conducting layer positioned between the substrate and the solid state electrolyte layer after the substrate is adhered with the colloidal electrolyte solution. Thus, the reference electrode in FIG. 3 can be formed. Besides, when the substrate is adhered with colloidal electrolyte solution in step 220, the colloidal electrolyte solution can be fixed in the groove of the reference electrode to form the reference electrode in FIG. 4.

The conducting layer can be formed by screen printing. In addition, the conducting structure comprises silver (Ag) and silver chloride (AgCl). The substrate of the reference electrode comprises one substance selected from the group consisting of the following or combination thereof: polycarbonate, polyester, polyether, polyamide, polyurethane, polyimide, polyvinyl chloride (PVC), glass, glass fiber plate, ceramics, polyethylene terephthalate (PET). The solid state electrolyte layer comprises potassium chloride (KCl) and polymer colloid where the polymer colloid covers potassium chloride.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A reference electrode, comprising:
a substrate;
a solid state electrolyte layer on said substrate;
a conducting structure connecting to said solid state electrolyte layer; and
a capillary structure connecting to said conducting structure;
wherein said solid state electrolyte layer is polymerized colloidal electrolyte solution.

2. The reference electrode according to claim 1, wherein said conducting structure is formed on said substrate by screen printing.

3. The reference electrode according to claim 1, wherein said conducting structure is located between said substrate and said solid state electrolyte layer.

4. The reference electrode according to claim 1, wherein said conducting structure is a conducting wire, and said conducting wire and said capillary structure are plugged in the colloidal electrolyte solution before polymerization.

5. The reference electrode according to claim 1, wherein said solid state electrolyte layer is located in a groove of said substrate.

6. The reference electrode according to claim 1, wherein said substrate comprises one substance selected from the group consisting of the following or combination thereof: polycarbonate, polyester, polyether, polyamide, polyurethane, polyimide, polyvinyl chloride (PVC), glass, glass fiber plate, ceramics, polyethylene terephthalate (PET).

7. The reference electrode according to claim 1, wherein said solid state electrolyte layer is polymer colloid covered with potassium chloride (KCl).

8. A sensing device, comprising: a reference electrode and a working electrode;
wherein said reference electrode comprises:
a first substrate;
a solid state electrolyte layer on said first substrate;
a conducting structure connecting to said solid state electrolyte layer; and
a capillary structure connecting to said conducting structure;
wherein said solid state electrolyte layer is polymerized colloidal electrolyte solution; and
when said capillary structure and said working electrode are placed in a test solution, said test solution is sucked to said solid state electrolyte layer by said capillary structure to have reaction; and said working electrode also reacts with said test solution so as to generate a potential difference between said reference electrode and said working electrode.

9. The device according to claim 8, wherein said conducting structure is formed on said first substrate by screen printing.

10. The device according to claim 8, wherein said conducting structure is located between said first substrate and said solid state electrolyte layer.

11. The device according to claim 8, wherein said working electrode further comprises a detachable element to replace said working electrode with different one.

12. The device according to claim 8, wherein said conducting structure is a conducting wire, and said conducting wire and said capillary structure are plugged in the colloidal electrolyte solution before polymerization.

13. The device according to claim 8, wherein said solid state electrolyte layer is located in a groove of said first substrate.

14. The device according to claim 8, wherein said working electrode comprises:
a second substrate;
an indium tin oxide layer (ITO) on said second substrate;
a sensing layer on said indium tin oxide layer; and
a sheathing layer on the area besides said sensing layer.

15. The device according to claim 14, wherein said sensing layer comprises one substance selected from the group consisting of the following or combination thereof: tin dioxide sensing film, potassium sensing film, sodium sensing film, chlorine sensing film, ammonium sensing film, urea enzyme film, creatinine enzymecreatinine enzyme film, and glucose enzyme film; said sensing layer comprises one substance selected from the group consisting of the following or combination thereof: tin dioxide sensing film, potassium sensing film, sodium sensing film, chlorine sensing film, ammonium sensing film, urea enzyme film, creatinine enzyme film, and glucose enzyme film; and said sheathing layer is of thermosetting material as Epoxy.

16. The device according to claim 8, further comprising: a signal processing device, separately connecting to said reference electrode and said working electrode, to process the signals outputted by said reference electrode and said working electrode; wherein said working electrode connects to said signal processing device via a conducting wire and said conducting wire connects to said indium tin oxide layer.

17. A method for fabricating a reference electrode, comprising the following steps:
providing a substrate;
having said substrate be adhered with colloidal electrolyte solution;
placing a capillary structure in said colloidal electrolyte solution; and
polymerizing said colloidal electrolyte solution to form a solid state electrolyte layer.

18. The method according to claim 17, wherein a conducting layer is formed on said substrate by screen printing before said substrate is adhered with said colloidal electrolyte solution.

19. The method according to claim 18, wherein said solid state electrolyte layer could positioned on said substrate, said conducting layer, or in a groove of said substrate.

20. The method according to claim 17, further comprising: placing a conducting wire in colloidal electrolyte solution before polymerization.
